(19) United States
(12) Patent Application Publication
(10) Pub. No.: US 2017/0085577 A1
(43) Pub. Date: Mar. 23, 2017

(54) COMPUTER METHOD FOR MAINTAINING A HACK TRAP

(71) Applicants: Lorraine Wise, Sparrows Point, MD (US); Marc George, Pasadena, MD (US)

(72) Inventors: Lorraine Wise, Sparrows Point, MD (US); Marc George, Pasadena, MD (US)

(21) Appl. No.: 15/273,112

(22) Filed: Sep. 22, 2016

Related U.S. Application Data
(60) Provisional application No. 62/221,873, filed on Sep. 22, 2015.

(51) Int. Cl. H04L 29/06

(52) U.S. Cl. CPC H04L 63/145; H04L 63/1491; H04L 63/1416

(57) ABSTRACT

A computer method for maintaining a hack trap by employing a Malware Diagnostics software module on every client system on the Internet. The Malware Diagnostics module includes a hacker spyware that communicates with a central data vault. The primary steps of the present method include: 1) deployment, by identifying the IP and MAC address of the hacker and downloading the Malware Diagnostics spyware; 2) monitoring, the Malware Diagnostics spyware covertly monitoring the hacker; 3) reporting, the Malware Diagnostics software module on the client system and the Malware Diagnostics downloadable infecting the hacker's system both reporting to a central geolocation server; 4) analyzing, the central geolocation server applying analytics to determine the geolocation and identity of the hacker; and 5) prosecuting, the central geolocation server preparing an indictment against the hacker for signature by the victim, as a formal accusation that the hacker has committed a crime.

### CROSS-REFERENCE TO RELATED APPLICATION(S)

The present application derives priority from U.S. Provisional Patent Application 62/221,873 filed 22 Sep. 2015.

### BACKGROUND OF THE INVENTION

1. Field of the Invention

The present invention relates generally to computer software, and more particularly, to a software method for creating and maintaining a hacker trap to identify and prosecute computer hackers, and thereby deter same.

2. Description of the Background

Hackers are committed to circumventing computer security, for good and bad. Black hat hackers pursue unauthorized break-ins to server networks via the Internet to steal personal information, bank data, identities, etc. In this age of Internet dependency, webmasters and technology administrators are extremely concerned by threat of hacking. Here are various types of attacks. One of the most common is the Distributed Denial of Service (DDoS) attack, which is usually aimed at networks by hackers attempting to gain access through open ports and connections in the home network or system. The hacker may undermine the network by flooding it with requests until one works, or they may use a specific authority obtained illegitimately, resembling a normal login process.

Every device that connects to an IEEE 802 network (such as Ethernet and WiFi) has a MAC-48 address, including every PC, smartphone or tablet computer. What is needed is a computer method of skip-tracing a hacker in order to catch hackers that attempt to infiltrate into business agencies, government or any home network.

### SUMMARY OF THE INVENTION

One aspect of the present invention provides a computer method for maintaining a hack trap by employing a skip trace software module on every client system on the Internet. The skip trace module includes a hacker spyware that communicates with a central data vault. The primary steps of the present method include: 1) Detection, using a locally-running Malware Diagnostics module to actively monitor and detect malware; 2) victim authorization, by which the Malware Diagnostics module notifies the victim of malicious code and solicits the victim's prosecution cooperation; 3) diagnostics, by which the locally-running Malware Diagnostics module on the victim's computer performs diagnostics to attain the IP Address and evidence of computer trespassing; 4) law enforcement authorization, by which the Malware Diagnostics component notifies a third party central geolocation server that prepares a Victim Impact, consolidates signed Victim Impact Statements, and facilitates issuance of a superseding indictment charging the hacker; 5) reverse infection and monitoring, including downloading a Malware Diagnostics spyware component to the hacker's computer, covertly monitoring the hacker, and reporting with a goal of prosecuting the hacker. In step 5, the Malware Diagnostics spyware component attaches to the hacker's computer and covertly monitors the hacker, reporting information and evidence to a secure data vault with a goal of prosecuting the hacker. The central data vault applies pattern detection algorithms to determine the physical location of the city, county or home address of the hacker. The hacker cannot see the software information being gathered. This protects the victim and prevents the hacker from being able to come up with a smarter way to break into systems.

The present invention is described in greater detail in the detailed description of the invention, and the appended drawings. Additional features and advantages of the invention will be set forth in the description that follows, will be apparent from the description, or may be learned by practicing the invention.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a block diagram illustrating a hacker computer 10 targeting a client computer 20 and a client cell phone 30 via the Internet.

FIG. 2 is a diagram of the primary software components involved in the distribution of malware, the subsequent remediation of its distribution to the victim and identification of the distributor.

FIG. 3 is a diagram, titled “HackerAttack Sequence”, of the sequence of interactions between the components identified in FIG. 2.

FIG. 4 is a sample snapshot of the geolocation results from ip2location com.

### DETAILED DESCRIPTION OF THE PREFERRED EMBODIMENTS

Reference will now be made in detail to preferred embodiments of the present invention, examples of which are illustrated in the accompanying drawings. Wherever possible, the same reference numbers will be used throughout the drawings to refer to the same or like parts.

The present invention provides a computer method for establishing a hack trap by running a Malware Diagnostics software module that monitors for access attempts by malicious client systems over the Internet or otherwise. If it detects a hack attempt, the Malware Diagnostics module covertly monitors the malware to establish computer trespass (the malware is communicating protected data back to the hacker) and to determine the hacker's IP address, and solicits the victim's consent to participate in prosecution. The foregoing information is then automatically reported to a third party central geolocation server, which employs analytics to determine the geolocation and identity of the hacker, automatically prepare a Victim Impact Statement against the hacker for signature by the victim. The central geolocation server consolidates signed Victim Impact Statements and provides an analytical dashboard to law authorities to encourage issuance of a wiretap subpoena against the hacker. Given both victim consent and law authority consent (subpoena) the third party central geolocation server automatically notifies the hacker's operating system (OS) Provider Update Service who notifies the “Hacker” of available operating system (OS) updates that tricks the hacker into a reverse-infection via update with a Malware Diagnostics spyware component that will covertly monitor the hacker, reporting to the third party central geolocation server which empowers law enforcement with the ability to directly monitor and/or control the hacker's computer to the point of possible disablement.

“Spyware” is herein defined as any software that enables a user to obtain covert information about another's computer activities by transmitting data covertly from their hard drive. “Hacker” is herein defined as any person who uses a computer to gain unauthorized access to data on a remote computer. “Malware” is herein defined as any malicious software used to disrupt computer operations, gather sensitive information, gain access to private computer systems, or display unwanted advertising.

For purposes of description the generalized steps of the present method are broken down as follows: 1) detection, using a locally-running Malware Diagnostics module to actively monitor and detect malware; 2) victim authorization, by which the Malware Diagnostics module immediately notifies the victim of the malicious code, solicits the victim's prosecution cooperation; 3) diagnostics, by which the locally-running Malware Diagnostics module on the victim's computer performs diagnostics on the malware to gather its IP Address and evidence of computer trespassing; 4) law enforcement authorization, by which the Malware Diagnostics component notifies a third party central geolocation server that prepares a Victim Impact Statement against the hacker for signature by the victim, consolidates signed Victim Impact Statements, and facilitates issuance of a superseding indictment charging the hacker; 5) reverse infection and monitoring, including downloading a Malware Diagnostics spyware component to the hacker's computer, covertly monitoring the hacker, and reporting with a goal of prosecuting the hacker.

The present software fully automates the foregoing five steps and when the Malware Diagnostics software module becomes prevalent on client systems on the Internet the present system will serve as a strong deterrent against hackers.

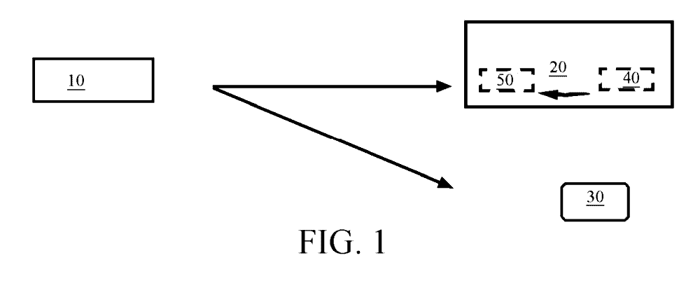

FIG. 1 identifies the general sequence and participants. During deployment a “Hacker” uses their hacker computing device 10 to initially target a victim's client computer 20 and/or a victim's client cell phone 30 via the Internet. In this instance the hacker computing device 10 accesses the victim's client computer 20 and installs a malware component 50 into the memory of victim's client computer 20. However, the victim has pre-loaded the Malware Diagnostics module 40 which has been instantiated and is running in the background. Malware Diagnostics module 40 actively monitors for the hacker component 50 (as will be described) and detects the malware component 50 install. Upon detecting the hacker component 50 the Malware Diagnostics module 40 presents a user interface to the victim by which it immediately notifies the victim of the malicious code, and solicits the victim's prosecution cooperation. If permission is granted, the Malware Diagnostics module 40 performs diagnostics on the malware component 50 and subsequently monitors the malware component 50 until two things are established: 1) an IP Address of a communications endpoint for traffic from the malware is determined; and 2) the hacker has violated 18 U.S.C. §1030(a)(2)(c) ([by] taking info from any protected computer), e.g., by communicating protected data back to the communications endpoint. Once the IP Address in identified and a crime established, the Malware Diagnostics component 40 automatically notifies a third party central geolocation server which employs analytics to determine the geolocation and identity of the hacker, and automatically prepares a Victim Impact Statement against the hacker for signature by the victim, as a formal accusation that the hacker has committed a crime. The notice to the third party geolocation server, return transmission of the Victim Impact Statement, and signature process therefor is preferably administered in a secure online manner using end-to-end online web processes with embedded electronic signing for authentication and evidentiary reasons, though one skilled in the art will understand that email or manual communications may alternatively be used.

The central geolocation server consolidates signed Victim Impact Statements and provides an analytical dashboard to law authorities to promote issuance of a superceding indictment charging the hacker. Law authorities my selectively pursue hackers based on the nature of the unlawful data, the identity of the victim, the public/private nature of the victim's computer, and/or the sheer number of hack attempts coming from a given hacker. However, once the law authorities decide to pursue a hacker they will apply for and have issued a federal wiretap subpoena. This serves as judicial authority for law enforcement to return to the legal dashboard and initiate the Monitoring Phase of the process.

During monitoring the third party central geolocation server automatically notifies hacker's operating system (OS) Provider Update Service of the infraction, IP Address of the Hacker component, and provides proof of the subpoena. The OS Provider Update Service notifies the “Hacker” of the availability of an update, and when the hacker accepts the ensuing update/download comprises a Malware Diagnostics spyware component that will covertly monitor the hacker. The Malware Diagnostics spyware component is initialized as part of the update process. The Malware Diagnostics spyware component reports to the third party central geolocation server which updates the Law Enforcement Dashboard on its availability and status. The Malware Diagnostics spyware may provide law enforcement with a back door access key to directly monitor and/or control the hacker's computer 10 to the point of possible disablement.

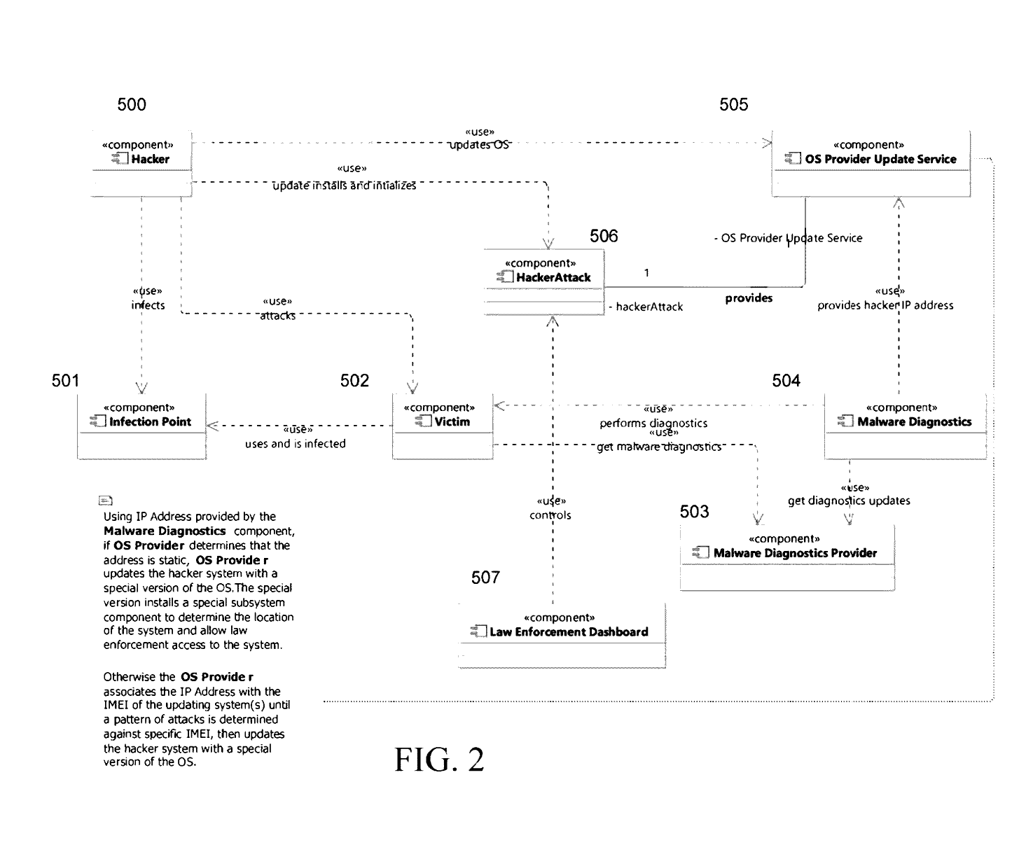

The foregoing steps are herein described in more detail with combined reference to FIGS. 2-4:

### Step 1: Detection

The Detection, using a locally-running Malware Diagnostics module to actively monitor and detect malware. FIG. 2 is a diagram of the primary software components involved in the distribution of malware, the subsequent remediation of its distribution to the victim and identification of the distributor, e.g. “Hacker”, for potential reactions by the appropriate law enforcement authorities. As seen in FIG. 2, in step 500, the “Hacker” uses their computing device 10 to infect in step 501 a victim's system with the Infection Point components, i.e., a malware distribution sub-system and the actual malware. The malware distribution sub-system is typically an executable file (commonly known as a downloader trojan or dropper) that downloads the actual malware. Malware distribution executables are difficult to distinguish from benign downloaders based only on their content, and so their behavior must be monitored. In step 502, the victim uses their computing device 20, the victim component, to interact with the infectious malware. In step 503, the “Victim” contacts a Malware Diagnostics Provider and obtains/installs the Malware Diagnostics component 40 if they have not already had one installed. The Malware Diagnostics component 40 runs in the background on client computer 20 and monitors for common hacker techniques. Toward this end, the Malware Diagnostics software module 40 is essentially a packet sniffer program that intercepts and decodes incoming network traffic making temporary copies of network packets sent by remote computers intended to be received by client 20. The Malware Diagnostics component 40 receives a copy of every packet transmitted through the Victim's network interface regardless of socket type, (TCP/UDP) port number and protocol. In step 504, the Malware Diagnostics component 40 performs diagnostics on the Victim component, the infected computing device 20, identifies the malware and its malicious nature.

### Step 2: Victim Authorization

Given a suspect hack attempt, the Malware Diagnostics module 40 immediately presents the victim with a user interface that notifies the victim of the malicious code, and solicits the victim's prosecution cooperation. The victim provides consent or not by a click-to-accept or decline control.

### Step 3: Diagnostics

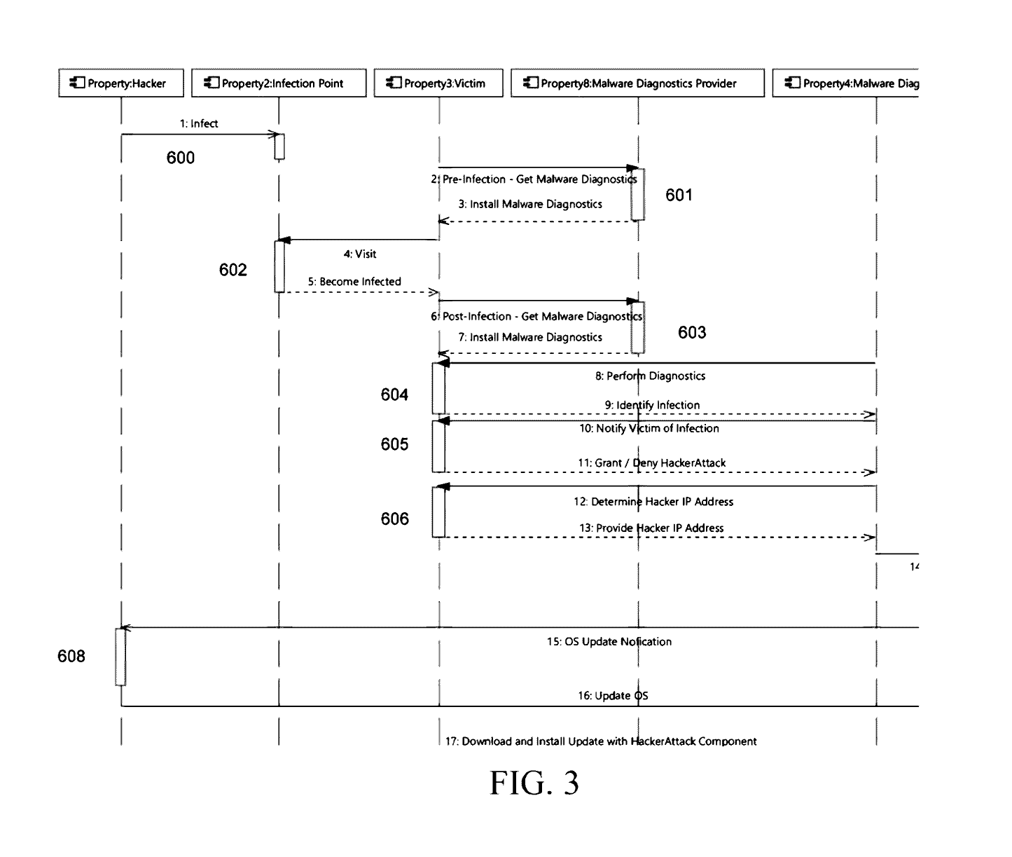

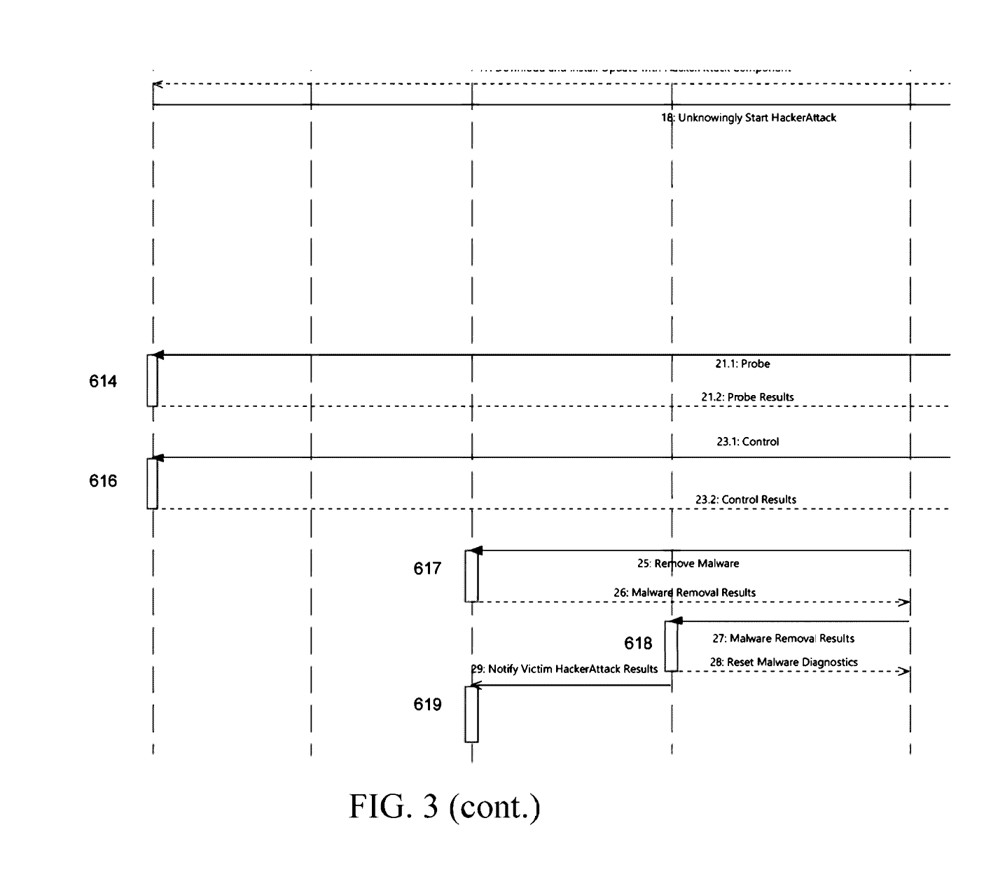

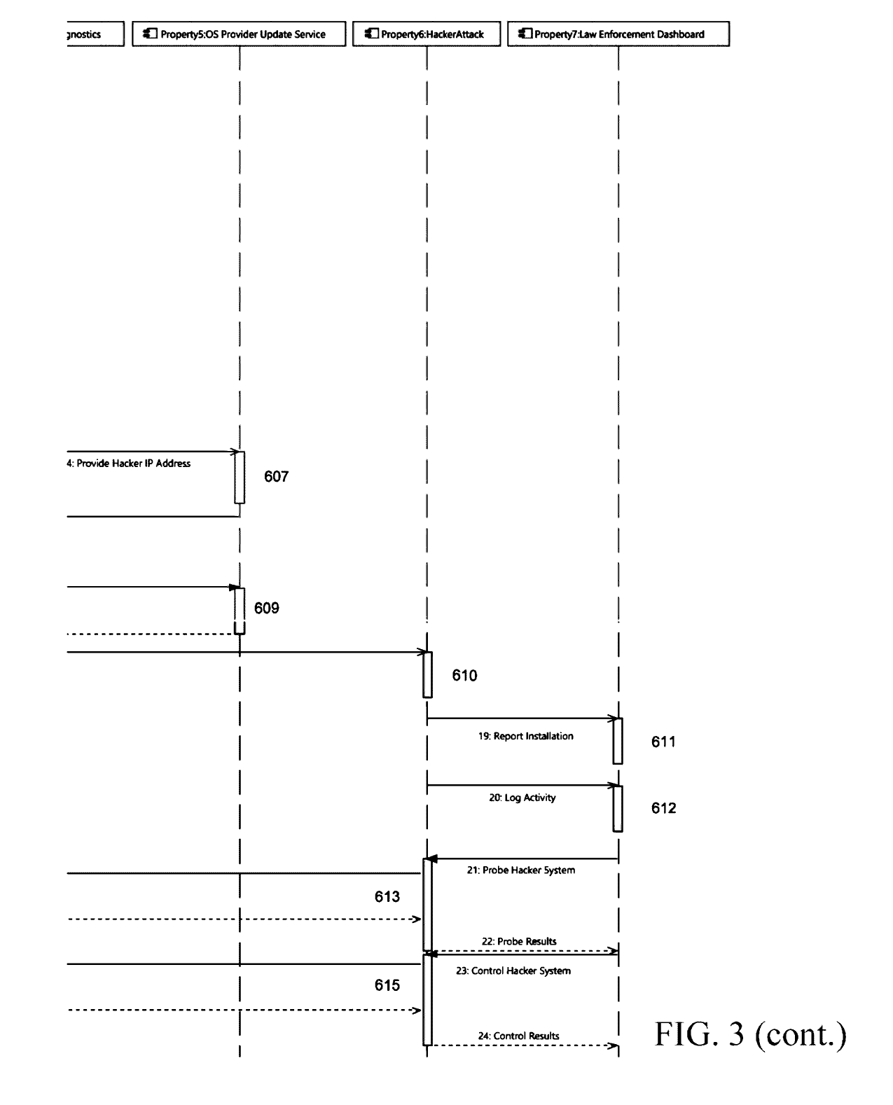

At this step the locally-running Malware Diagnostics module 40 on the victim's computer performs diagnostics on the malware to gather its IP Address and evidence of computer trespassing. It does this by monitoring the malware until 1) an IP Address of a communications endpoint for traffic from the malware is determined, and 2) evidence that the hacker has violated 18 U.S.C. §1030(a)(2)(c) ([by] is compiled by the malware exporting/taking data from the victim's computer), e.g., by communicating protected data back to the communications endpoint. The Malware Diagnostics software module 40 identifies the IP and MAC address of the intruder using a tool to identify the address of whoever is trying to connect to victim client computer 20. An IP address is assigned to every device on a network so that device can be located on the network. MAC addresses are typically used only to direct packets device-to-device, and so if the hacker is working through a router the router's MAC address will show up in packets sent further upstream. As shown collectively in FIG. 3 steps 603-606 the Malware Diagnostics software module 40 identifies the IP and MAC address using a tool such as Netstat. Netstat is a command-line tool that displays network connections for the Transmission Control Protocol (both incoming and outgoing), routing tables, and a number of network interface (network interface controller or software-defined network interface) and network protocol statistics. At step 505, the IP Address is provided to a third party geolocation server which employs analytics to determine the geolocation and identity of the hacker. The analytics are used as described in more detail below to determine geographic locations from the hacker's IP address. Given geolocation and IP data, and logged evidence of computer trespassing (by monitoring data exported to the hacker's IP address), the Malware Diagnostics software module 40 compiles the information and automatically prepares a Victim Impact Statement against the hacker for signature by the victim, as a formal accusation that the hacker has committed a crime. Again, the Malware Diagnostics module 40 presents the Victim Impact Statement via the user interface and provides an electronic signature capability, and the signed Victim Impact Statement is transmitted to the third party geolocation server.

### Step 4: Law Enforcement Authorization

Given the IP Address, location, possible identity and evidence of the computer trespass from Step 3, the third party geolocation server automatically consolidates signed Victim Impact Statements for each identified hacker, and facilitates issuance of a superseding indictment charging the hacker. Specifically, the central geolocation server consolidates signed Victim Impact Statements and provides an analytical dashboard at step 507 to law authorities to encourage issuance of a superseding indictment charging the hacker. Law authorities my selectively pursue hackers based on the nature of the unlawful data, the identity of the victim, the public/private nature of the victim's computer, and/or the sheer number of hack attempts coming from a given hacker. However, once the law authorities decide to pursue a hacker they will apply for and have issued a federal wiretap subpoena. This serves as judicial authority for law enforcement to return to the legal dashboard and initiate the Monitoring Phase of the process.

### Step 5: Reverse Infection And Monitoring

This step includes downloading a Malware Diagnostics spyware component 50 to the hacker's computer, covertly monitoring the hacker, and reporting with a goal of prosecuting the hacker. To do this, during monitoring the third party central geolocation server automatically notifies hacker's operating system (OS) Provider Update Service of the infraction, IP Address of the Hacker component, and provides proof of the subpoena.

At step 505 (FIG. 2), the IP Address is provided to the OS's (Operating System) Providers) along with proof of subpoena. Subsequently, and as described in detail below with regard to FIG. 3 step 608, when a OS Provider Update Service is contacted by the Hacker component for availability of updates, the OS Provider Update Service indicates an OS update is available. Alternatively, the OS Provider Update Service may push a Provider Update Notice to the hacker. When the “Hacker” updates, the OS Provider Update Service includes in the update the HackerAttack component.

Once installed, in step 506, the HackerAttack component reaches out to the Law Enforcement Dashboard to announce its activation. Alternately, the OS Provider Update Service notifies the “Hacker” of the availability of an update, and when the hacker accepts the ensuing update/download comprises a Malware Diagnostics spyware component that will covertly monitor the hacker. The Malware Diagnostics spyware component 50 is initialized as part of the update process.

In step 507 “Law Enforcement” can then use the Law Enforcement Dashboard to probe and control the “Hacker's” computing device for additional evidence of criminal activity, location and possible disablement. The Malware Diagnostics spyware component 50 reports to the third party central geolocation server which updates the Law Enforcement Dashboard on its availability and status (see below FIG. 3 step 611). The Malware Diagnostics spyware 50 covertly monitors the hacker, logs activity (step 612), and reports its findings to the third party server (step 613). More specifically, the Malware Diagnostics spyware 50 includes a key logger to record every keystroke the hacker makes, and an IP/MAC address recorder for recording every IP and MAC address the hacker connects to. This data is periodically uploaded to the geolocation server. The Malware Diagnostics spyware 50 is tagged with the identity of the Malware Diagnostics software module 40 that downloaded it, and so all spyware 50 data is indexed and stored in association with the original Hacker IP/MAC address uploaded to geoocation server by the Malware Diagnostics software module 40.

The Malware Diagnostics spyware 50 may also provide law enforcement with a back door access key to directly monitor and/or control the hacker's computer 10 to the point of possible disablement (see below step 615).

FIG. 3 is a diagram, titled “HackerAttack Sequence”, of the sequence of interactions between the components identified in FIG. 2 involved in the distribution of malware, the subsequent remediation of its distribution to the victim and identification of the distributor, e.g. “Hacker”, for potential reactions by the appropriate law enforcement authorities.

In FIG. 3, in step 600, the “Hacker” uses their computing device, the Hacker component 10, to infect a system, either public or private, the Infection Point, with a malware distribution sub-system and the actual malware to be distributed.

Prior to visiting the Infection Point, in step 602, the “Victim”, in step 601, may have already obtained the Malware Diagnostics component from the Malware Diagnostic Provider component and installed it on the Victim component. Otherwise, after visiting the Infection Point and becoming infected, the “Victim”, in step 603, visits and obtains the Malware Diagnostics component 40 from the Malware Diagnostic Provider component and installs it on the Victim component.

In step 604, the Malware Diagnostics component performs diagnostics on the Victim component, the infected computing device, identifies the malware.

Once the Malware Diagnostics component 40 identifies the malware, in step 605, the Malware Diagnostics component 40 informs the “Victim” 20 of the situation and asks for their co-operation in performing the “Hacker Attach”. If the co-operation is not granted, the Malware Diagnostics component 40 jumps to step 617.

If co-operation is granted, the Malware Diagnostics component 40, in step 606, performs diagnostics on the Victim component, the infected computing device 20, identifies the malware and subsequently monitors the malware until an IP Address of a communications endpoint for traffic from the malware is determined, and evidence of illicit data exportation is captured and preserved.

As described above in steps 3 and 4, the IP Address is provided to the third party geolocation server which determines geolocation and identity of the hacker along with logged evidence of computer trespassing, the Victim Impact Statement is signed and consolidated as necessary for law enforcement authorization to issue a wiretap subpoena. Given the identified IP Address, geolocation and law enforcement authorization, in step 607, the geolocation server notifies the OS Provider Update Service of the IP Address of the Hacker component.

In step 608, either the OS Provider Update Service notifies the “Hacker” of the availability of an update or when the OS Provider Update Service is contacted by the Hacker component in step 609 to determine availability of updates, the OS Provider Update Service indicates an OS update is available.

When the “Hacker” updates their Hacker component, step 609, the OS Provider Update Service includes in the update the HackerAttack component. The HackerAttack component is initialized as part of the update process.

With the HackerAttack component initialized, in step 611 it reports to the Law Enforcement Dashboard it availability on status.

In step 612, the HackerAttack component begin logging its activities to the Law Enforcement Dashboard.

“Law Enforcement” begins in steps 613 and 614 to probe “Hacker's” computing device for additional evidence of criminal activity and location.

In steps 615 and 616, the HackerAttack component enables “Law Enforcement” via the Law Enforcement Dashboard to control the Hacker component to the point of possible disablement.

in step 617, the Malware Diagnostics component removes the malware from the Victim component.

In step 618, the Malware Diagnostics component updates the Malware Diagnostic Provider component with the results of its activities and resets itself.

In step 618, the Malware Diagnostics component updates the “Victim” of the results of its activities via the Victim component.

### Geolocation Server

The geolocation server includes a geolocation database by which it uses geolocation analytics. The geolocation analytics employs a two-pass approach, first using the initial IP/MAC address and second using the data uploaded from spyware 50 to corroborate the initial location. Using the original IP/MAC address it is possible to roughly map the IP locations using any of the following web services:
http://www.liveipmap.com
http://www.ip-address.com
http://www.whatismyip.com/tools/ip-address-lookup.asp

Each service uses a different geolocation database and tries to find the Internet router that's closest to the hacker's IP address.

As an example, entering the IP address in the dialog box and clickinbg “Find Location” at http.//www/ip2location.com/demo.aspx provides the following information for any given IP address:
Country in which the IP is located
City to which the IP address belongs to
Latitude/Longitude of the IP's location
Zip Code of the region to which the IP belongs to
Time Zone associated with the IP
Name of the ISP to which the IP address belong to
Internet Speed of the computer associated with the IP
Weather Station associated with the region of the IP
Domain name associated with the IP address

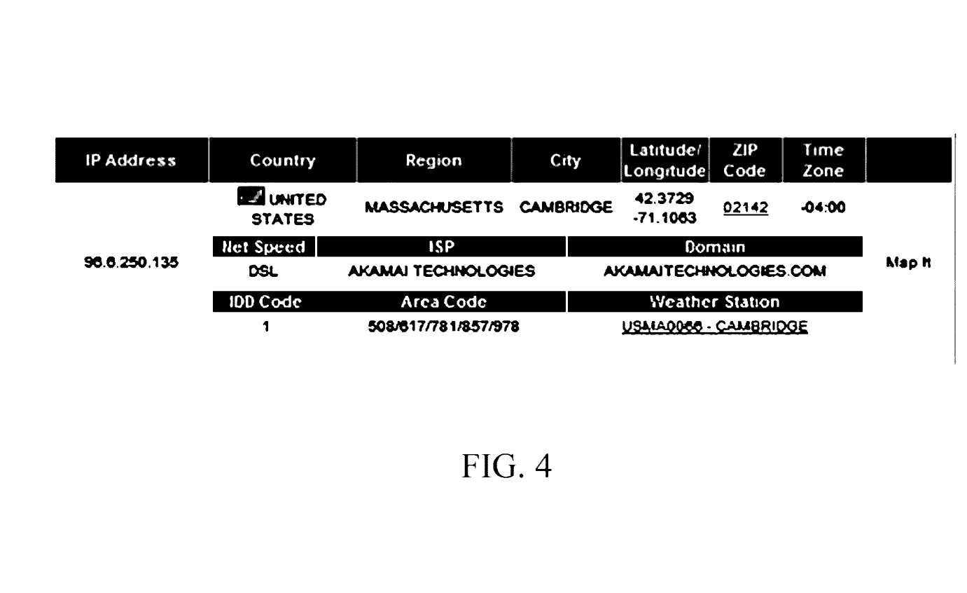

A sample snapshot of the results from ip2location.com is given in FIG. 4.

The accuracy of the result depends on the database used and the number of known routers in the hacker's IP area. While IP address geolocation is not perfect, it's mostly accurate. Estimates reach from 60% accuracy all the way up to 95% accurate. Thus, to corroborate the foregoing the geolocation server applies pattern detection algorithms to the spyware 50 data indexed to the original Hacker IP/MAC address to determine the identity and physical location of the city, county or home address of the hacker. The geolocation server pattern detection algorithms applied to the spyware 50 data look for electronic signatures to identify the user, such as browser fingerprints, computer fingerprints, IP addresses, geographic IP location information, information associated with a payment, and/or a typing patterns. Such information may comprise an electronic signature and may uniquely identify a hacker 10. The data vault relies on the continuous data from spyware 50 and historical data from other users until the hacker's actual identity and geolocation is pin pointed.

### Summary Indictment Request

With all the foregoing evidence and information in hand, the geolocation server may prepare an indictment request. The request incudes an indictment record of evidence taken from the data and a submission link to submit the indictment request to the following authorities:
The FBI Internet Crime Complaint Center (IC3).
The US-CERT Incident Reporting System.
BroadbandDSLReports.com.
The Federal Trade Commission.
Anti-virus/malware and firewall vendors

A submitted indictment request provides all required information to prosecute the hacker 10. By alerting authorities the present invention provides significant deterrent value to hackers. Once a hacker is registered in the geolocation server and is caught or imprisoned they then are placed on a watch list and never have use of the internet again.

Other embodiments of the invention will be apparent to those skilled in the art from consideration of the specification and practice of the invention disclosed herein. It is intended that the specification and examples be considered as exemplary only, with a true scope and spirit of the invention being indicated by the claims. In addition, as one of ordinary skill in the art would appreciate, any dimensions shown in the drawings or described in the specification are merely exemplary, and can vary depending on the desired application of the invention. Many variations and modifications of the embodiment described herein will be obvious to one of ordinary skill in the art in light of the above disclosure. The scope of the invention is to be defined only by the claims, and by their equivalents.

We claim:

1. A computer method for maintaining a hack trap, comprising the steps of:
installing a Malware Diagnostics module that communicates with a central data vault on a client computer;
said Malware Diagnostics module being configured to monitor for malicious network traffic to detect a malware installation on said client computer;
upon detection of a malware installation on said client computer, said Malware Diagnostics module identifying an IP address of network traffic caused by said malware installation;
said Malware Diagnostics module uploading said IP address of the hacker to a geolocation server;
said geolocation server determining a geographical location of said IP address;
said geolocation server soliciting legal authority to covertly monitor a computer at said IP address;
said geolocation server transmitting said hacker IP address and proof of legal authority to an operating system (OS) provider update service;
said OS provider update service notifying the hacker of availability of an OS update and downloading a malware diagnostics spyware software module to the computer at said IP address;
said malware diagnostics spyware software module covertly monitoring the hacker computer and transmitting results to said geolocation server.

2. The computer method for maintaining a hack trap according to claim 1, wherein said Malware Diagnostics software module monitors said malware component to determine an IP Address of an endpoint for traffic from the malware component.

3. The computer method for maintaining a hack trap according to claim 2, wherein said Malware Diagnostics software module monitors said malware component to establish data exportation to said IP address.

4. The computer method for maintaining a hack trap according to claim 1, wherein said Malware Diagnostics spyware includes a key logger.

5. The computer method for maintaining a hack trap according to claim 4, wherein said Malware Diagnostics spyware includes an IP/MAC address recorder for recording every IP and MAC address the hacker connects to.

6. The computer method for maintaining a hack trap according to claim 5, wherein said Malware Diagnostics spyware includes a key logger.

7. A computer method for prosecuting computer hackers, comprising the steps of:
instantiating a Malware Diagnostics software module on a client computer to monitor for access attempts by malicious hacker computer systems over the Internet;
detecting by said Malware Diagnostics software module a suspicious access attempt;
said Malware Diagnostics software module presenting a user interface on said client computer and soliciting prosecution cooperation;
said Malware Diagnostics software module performing diagnostics to attain an IP Address and evidence of computer trespassing;
said Malware Diagnostics software module transmitting said IP Address and evidence of computer trespassing to a central geolocation server;
said central geolocation server soliciting legal wiretap authority;
transmitting by said central geolocation server said IP Address and proof of legal wiretap authority to an operating system (OS) provider update service;
said OS provider update service notifying the malicious hacker computer system of availability of an OS update;
said OS provider update service downloading a malware diagnostics spyware software module to said malicious hacker computer system;
said central geolocation server covertly monitoring the malware diagnostics spyware software module and logging data therefrom;
said central geolocation server communicating the logged data to a law enforcement authority computer system.

8. The computer method for prosecuting computer hackers according to claim 9, wherein said Malware Diagnostics software module detects a malware component.

9. The computer method for prosecuting computer hackers according to claim 8, wherein said Malware Diagnostics software module monitors said malware component to determine an IP Address of an endpoint for traffic from the malware component.

10. The computer method for prosecuting computer hackers according to claim 9, wherein said Malware Diagnostics software module monitors said malware component to establish data exportation to sadi IP address.

11. The computer method for prosecuting computer hackers according to claim 7, wherein said Malware Diagnostics spyware includes a key logger.

12. The computer method for prosecuting computer hackers according to claim 11, wherein said Malware Diagnostics spyware includes an IP/MAC address recorder for recording every IP and MAC address the hacker connects to.

13. The computer method for prosecuting computer hackers according to claim 8, wherein said Malware Diagnostics software module detects a malware component.

14. The computer method for prosecuting computer hackers according to claim 13, wherein said Malware Diagnostics software module monitors said malware component to determine an IP Address of an endpoint for traffic from the malware component.

15. The computer method for prosecuting computer hackers according to claim 14, wherein said Malware Diagnostics software module monitors said malware component to establish data exportation to said IP address.

16. The computer method for prosecuting computer hackers according to claim 7, wherein said Malware Diagnostics spyware includes a key logger.

17. The computer method for prosecuting computer hackers according to claim 16, wherein said Malware Diagnostics spyware includes an IP/MAC address recorder for recording every IP and MAC address the hacker connects to.
